(19) United States
(12) Patent Application Publication
(10) Pub. No.: US 2016/0049701 A1
(43) Pub. Date: Feb. 18, 2016

(54) PROCESS FOR PREPARING AND RECYCLING CATHODE ACTIVE MATERIALS FOR LITHIUM-ION BATTERIES

(71) Applicant: FARASIS ENERGY, INC., Hayward, CA (US)

(72) Inventors: Keith D. KEPLER, Belmont, CA (US); Floris TSANG, Walnut Creek, CA (US); Robbert VERMEULEN, Pleasant Hill, CA (US); Phillip HAILEY, Oakland, CA (US)

(21) Appl. No.: 14/826,166

(22) Filed: Aug. 13, 2015

Related U.S. Application Data
(60) Provisional application No. 62/036,906, filed on Aug. 13, 2014.

(51) Int. Cl. H01M 10/54; C25B 1/21; H01M 4/525; H01M 10/0525; C25B 1/14; H01M 4/505

(52) U.S. Cl. CPC H01M 10/54; C25B 1/14; H01M 4/505; H01M 4/525; H01M 10/0525; C25B 1/21; H01M 2004/028

(57) ABSTRACT

Herein is disclosed a process for preparing a cathode active material for lithium-ion batteries, comprising preparing a slurry by mixing a lithium-deficient cathode active material for lithium-ion batteries with a solution containing lithium-ions; and applying a direct current in the slurry using a working electrode and a counter electrode. A method for recycling the cathode active material from lithium-ion batteries is also provided. The process of the invention can be used to recycle the cathode active material from used or waste lithium-ion batteries efficiently and at low cost, and the recycled cathode active material can be used to prepare new lithium-ion batteries.

### CROSS-REFERENCE TO RELATED APPLICATION

This application claims priority to U.S. provisional application Ser. No. 62/036,906, filed on Aug. 13, 2014, entitled “Method and Apparatus for Changing the State of Charge of Battery Active Materials”, which is specifically and entirely incorporated by reference.

### FIELD OF THE INVENTION

This application relates to the field of lithium-ion batteries, and particularly to a process for preparing and recycling cathode active materials for lithium-ion batteries.

### BACKGROUND OF THE INVENTION

Lithium-ion batteries are rapidly becoming the dominant rechargeable energy storage technology for a wide range of applications. Their use is expected to grow rapidly as new applications in the transportation and energy distribution markets (Electric Vehicles, HEV's, Load-Leveling, etc.) begin to adopt lithium-ion batteries to achieve greater efficiencies and address issues such as global warming. The size and number of batteries for these applications is huge, greatly surpassing the already large volume of cells being used in most consumer electronics applications. Because of this there is a great desire to be able to recycle the materials used in lithium-ion batteries to decrease their impact on the environment and to keep them out of landfills.

Often there are a number of valuable materials used in the construction of lithium-ion cells, including Cu and Al foils, and most of the cathode active materials currently in use contain Co, Ni or other transition metals. Conventional methods of recycling lithium-ion cells and other battery systems such as Pb-acid batteries, typically involve a smelting process where old cells and batteries are melted down and the valuable metals are recovered from the melt. The process works well but often cannot be justified economically if the metals to be recovered are not high value, since the recovered materials must compete with newly mined sources. Also many elemental components from the cell, such as lithium and carbon, can be lost in such a process. Furthermore, in the case of battery materials the processing cost of making the precursor components (usually hydroxides, carbonates or oxides of transition metals for cathodes, and carbon pitch for the anode) and the final battery active materials (ex. LiCoO₂, LiNiCoO₂, LiNiCoMnO₂, LiMn₂O₄, and LiFePO₄ for the cathode, or graphite for the anode) from the starting elements (Carbon, Li, Co, Mn, Ni, Fe metals) can be high relative to the cost of the starting components. Thus it would be desirable from both a cost and environmental impact standpoint to be able to recover the active materials from a lithium-ion cell and regenerate them to their pristine state for re-use in a new lithium-ion cell without having to first decompose them into their elemental components. Such a process would avoid the additional costs associated with re-synthesizing the active materials from the recycled, recovered metals.

When lithium-ion cells are first assembled they are typically in a discharged state. Consequently, the active materials of the cathode and anode are defined as being in the discharged state when the cell is assembled. Once the cell is formed during the first cycle, the active materials can no longer achieve their original completely discharged state even if the cell is “fully” discharged, since inherent loss of lithium during formation leads to a reduced amount of lithium available for reinsertion into the active cathode material structure. Thus, after formation the cathode material will always have less lithium than when it was used to make the cell originally.

Furthermore, the state of charge of a cell to be recycled can vary tremendously. It may be fully charged or fully discharged or somewhere in between, meaning that the amount of lithium in the cathode and anode can vary greatly. If the cells are fully charged then the cell active materials would theoretically be in a non-equilibrium state (ex. Li_{0.5}CoO₂, LiC₆) where the cathode is partially de-lithiated and the anode is partially lithiated. In this state, neither material could be used to make new lithium-ion cells. If the cells are fully discharged then theoretically, the cathode and anode would be in their originally assembled, fully lithiated state (ex. LiCoO₂ and C) and, if recovered, a new lithium-ion cell could be made. However, any cell that has been cycled has already lost some lithium to a number of unavoidable processes, including the formation of a surface electrolyte interfacial layer at the carbon anode, or to ongoing loss of lithium to other side reactions. Thus it is not possible to simply discharge a cell, open it and recover fully lithiated cathode and fully de-lithiated anode active materials for use in a new lithium-ion cell. There will always be the necessity of adding lithium to cathode material recovered from a lithium-ion cell to make the stoichiometric discharged composition, and of removing lithium from an anode material recovered from a lithium-ion cell to make the stable de-lithiated form. Only after that is done can lithium-ion active materials recovered from a lithium-ion cell be re-used to make a new lithium-ion cell. However, if this can be done using an economical process, recycled materials from lithium-ion cells may be a cheaper and more environmentally friendly alternative to making the active materials from heavily processed raw materials.

Methods of re-lithiating a partially de-lithiated cathode material include a number of possible processes. The most straightforward is to mix the partially de-lithiated cathode material with a lithium source such as lithium hydroxide or lithium carbonate, followed by firing the mixture at elevated temperature. This method only works if the exact amount of lithium required is known, which would be difficult if not impossible to determine for a large batch of recycled material from many different batteries, each at a different state of charge. Also some current active cathode materials would not be stable to this reaction, particularly if there is a mixture of different cathode materials that cannot be separated. For example, LiNiCoO₂ will react with LiMn₂O₄ at low temperatures to form an inactive phase. The layered composite cathode active materials with the general formula Li₁₊ₓNiCoMnO₂ may also be difficult to recover using this method.

Another possible process is to use chemical reduction in solutions of lithium-iodide or lithium alkoxide, among other methods. (U.S. Pat. No. 6,652,605) Besides the expense and the necessity of removing residual salts from the re-lithiated cathode material, there is the problem of achieving a stoichiometric material. For example LiMn₂O₄ may be over-lithiated in such a solution to Li_{1.2}Mn₂O₄ which, makes it difficult to use in lithium-ion cell. Electrochemical methods have also been used to lithiate lithium-deficient cathode materials (ex. J. Electrochemical Society, Vol 141, No 9, p. 2310 (1994), however, the method required the cathode material to be applied as a paste to an electrode and is not compatible with mass conversion of a material.

### SUMMARY OF THE INVENTION

This invention provides a process for preparing and recycling a cathode active material for lithium-ion batteries.

In one aspect, a process for preparing a cathode active material for lithium-ion batteries is provided, comprising

preparing a slurry by mixing a lithium-deficient cathode active material for lithium-ion batteries with a solution containing lithium-ions; and

applying a direct current in the slurry using a working electrode and a counter electrode.

The direct current may be applied so as to establish an equilibrium voltage between the working electrode and the counter electrode corresponding to the fully lithiated state of the cathode active material.

The solution containing lithium-ions may be an aqueous solution of LiOH, LiNO₃, Li₂SO₄, or other lithium salt; or the solution containing lithium-ions may bean electrolyte solution for lithium-ion batteries.

The slurry may be placed in an electrochemical vessel, the walls of which act as the working electrode, and the counter electrode is provided penetrating through parts of the wall of the electrochemical vessel while being electrically isolated from the vessel.

The electrochemical vessel may be provided with a mixing blade to stir the slurry during the electrochemical lithiation, and the blade may also act as the working electrode.

The counter electrode may be any chemically and electrochemically stable electron-conductive material, for example carbon (rod or sheet), platinum, stainless steel or other metals. Preferably, the counter electrode comprises lithium metal. The counter electrode may be coated with a membrane or material that is permeable to lithium-ions.

The electrochemical vessel may be further provided with a conductive mesh which acts as the working electrode and through which the slurry may be pumped continuously.

The solution containing lithium-ions may have a concentration of 0.1-5 mol/L lithium ion. Relative to the amount of lithium to be replenished in the lithium-deficient cathode active material, the lithium ions in the solution may be sufficiently excessive so as to fully lithiate the lithium-deficient cathode active material.

The direct current may be controlled such that voltage between the working electrode and the counter electrode is kept greater than or equal to the voltage corresponding to the fully lithiated state of the cathode active material.

The lithium-deficient cathode active material may be selected from all of the known cathode materials that can be used as the cathode active material for lithium-ion batteries, such as one or more of Li₁₋ₓCoO₂, Li₁₋ₓNiCoO₂, Li₁₋ₓNiCoMnO₂, Li₁₋ₓMn₂O_{4,}Li₁₋ₓNiCoAlO₂, Li₁₋ₓFePO₄ , and so on, where x is greater than 0 and less than 1.

In another aspect, a method for recycling a cathode active material from a lithium-ion battery is provided, comprising

collecting a lithium-deficient cathode active material from lithium-ion batteries, and

preparing a slurry by mixing the lithium-deficient cathode active material with a solution containing lithium-ions; and

applying a direct current in the slurry using a working electrode and a counter electrode.

The method may further comprise collecting the cathode active material from the slurry after an equilibrium voltage, corresponding to the fully lithiated state of the cathode active material, is established between the working electrode and the counter electrode.

The cathode active material may be collected by filtration or evaporation or other means.

The process of the invention could be used to recycle cathode active material from used or waste lithium ion batteries efficiently and at low cost, and the recycled cathode active material could be used to prepare new lithium ion batteries.

Other independent features and independent aspects of the invention will become apparent by consideration of the following detailed description, claims and accompanying drawings.

### BRIEF DESCRIPTION OF THE DRAWINGS

FIG. 1 illustrates one embodiment of the electrochemical vessel used for the process of the invention.

FIG. 2 illustrates one embodiment of the counter electrode of the electrochemical vessel.

### REFERENCE SIGNS

1—Side of Vessel acting as Working Electrode
2—Mixing Blade acting as Working Electrode
3—Counter Electrode
4—Slurry
5—External Circuit from working electrodes to galvanostaticor potentiostatic control
6—External Circuit from counter electrodes to galvanostaticor potentiostatic control
7—Ceramic lithium-ion conductor
8—Lithium metal
9—Conductive support for Lithium metal electrode
10—Spring to apply pressure to Lithium metal
11—Conductive backing, insulated from working electrode surface
12—Insulating clamps to hold counter electrode in place

### DETAILED DESCRIPTION

Before any independent embodiments of the present invention are explained in detail, it should be understood that the invention is not limited in its application to the details or construction and the arrangement of components as set forth in the following description or as illustrated in the drawings. The invention is capable of other independent embodiments and of being practiced or of being carried out in various ways.

It should be understood that the description of specific embodiments is not intended to limit the disclosure from covering all modifications, equivalents and alternatives falling within the spirit and scope of the disclosure. Also, it is to be understood that the phraseology and terminology used herein is for the purpose of description and should not be regarded as limiting.

The method of the invention is suitable for recycling the cathode active material from any used or waste lithium ion batteries. The lithium-deficient cathode active material may be selected from the group consisting of Li₁₋ₓCoO₂, Li₁₋ₓNiCoO₂, Li₁₋ₓNiCoMnO₂, Li₁₋ₓMn₂O_{4,}Li₁₋ₓNiCoAlO₂, Li₁₋ₓFePO₄ (where x is greater than 0 and less than 1), and the thus prepared cathode active material may be selected from the group consisting of Li_{1-y}CoO₂, Li_{1-y}NiCoO₂, Li_{1-y}NiCoMnO₂, Li_{1-y}Mn₂O₄Li_{1-y}NiCoAlO₂, Li_{1-y}FePO₄ (where y is greater than or equal to 0 and less than 1, and y is less than x).

The lithium-deficient cathode active material may be collected from used or waste lithium ion batteries in the form of powders or slurries.

The solution containing lithium-ions may be an aqueous solution of LiOH, LiNO₃, Li₂SO₄, or other lithium salts; or the solution containing lithium-ions may be an electrolyte solution for lithium-ion batteries. The electrolyte solution may be a non-aqueous solution containing LiPF₆ or some other lithium-ion salt typically used in lithium-ion batteries.

The slurry may be placed into an electrochemical vessel, the walls of which act as the working electrode, and the counter electrode is provided penetrating through parts of the wall of the electrochemical vessel while being electrically isolated from the vessel.

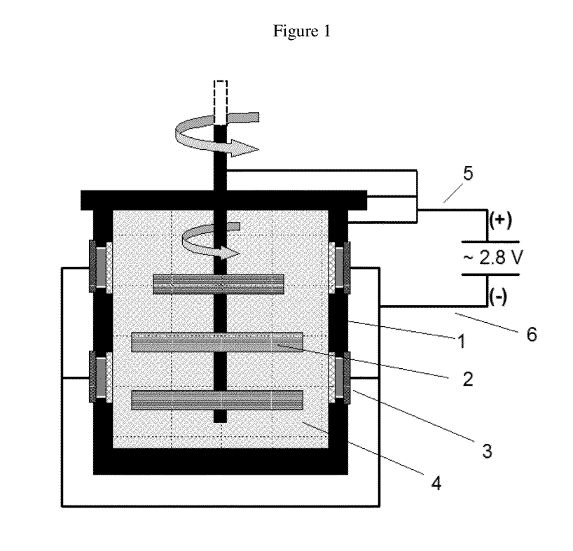

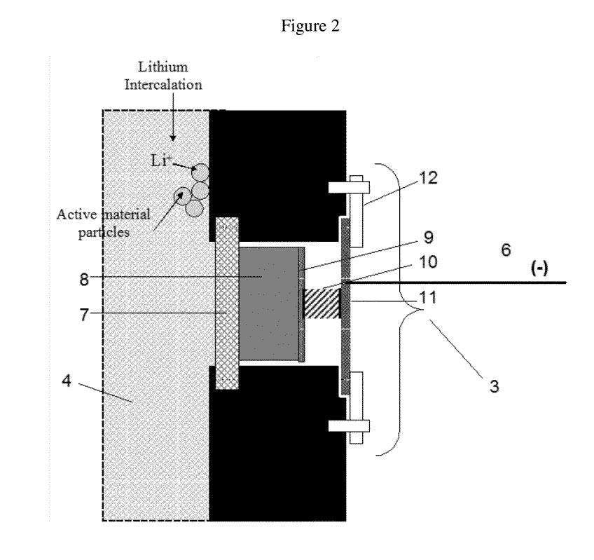

FIG. 1 illustrates one embodiment of the electrochemical vessel used for the process of the invention. As shown in FIG. 1, the slurry is placed into an electrochemical vessel with a mixing blade, both of which have a surface exposed to the slurry and act as working electrodes. Preferably, the working electrode comprises the majority of the vessel surface, and may also include the blade used to mix the slurry. A counter electrode surface is also exposed to the slurry. As shown in FIG. 2, the counter electrode may include a separator material that isolates the active electrode from direct contact with the slurry solid components. Possible anode materials include a carbon anode, a metallic anode or a lithium metal anode. The anodes may be constructed with high surface area to minimize their volume or footprint in the electrochemical vessel. Preferably, the surface areas of the working electrode and counter electrode are similar. The slurry is mixed with the blade and the working and counter electrode surfaces are connected to a galvanostaticor potentiostatic device external to the vessel. An electrochemical cell voltage is established based on the state of charge of the slurry active cathode material component, periodically touching the working electrode, vs. the counter electrode voltage. Once an equilibrium voltage has been established for the slurry vs. the counter electrode, a voltage or current can be applied across the two electrodes to cause the system to charge or discharge, thus changing the state of charge of the slurry active component. The voltage or current can be sustained until the electrochemical vessel reaches the desired voltage. The slurry can then be removed and the solids separated from the solution by filtration or evaporation or other methods followed by further washing to remove excess salt and eventual drying. The material may also be fired to remove other contaminants and to clean the surfaces of the active materials.

In another aspect of this invention the electrochemical lithiation process works in series with a chemical lithiation process. For example, when an aqueous electrolyte comprising LiOH is used, the cathode material placed in the vessel may spontaneously take up lithium from the solution with evolution of oxygen, depending on the initial state of charge and voltage of the cathode particles. The voltage of oxygen formation in concentrated LiOH is approximately 3.5V vs. lithium metal.

This reduction-oxidation reaction (1) will drive the re-lithiation of a cathode material until the cathode voltage reaches a state of charge corresponding to roughly 3.5V vs. lithium. For most cathode materials for lithium-ion batteries this does not correspond to a fully lithiated state, which is typically below 3V.

Li₁₋ₓCoO₂+Li⁺+OH→Li_{1-y}CoO₂+O₂+H₂O (where y<x) (1)

Other chemical lithiation reactions suitable for this process are well known in the literature. Those that do not result in complete lithiation of the cathode materials are suitable for this process.

To achieve further lithiation beyond the spontaneous chemical reaction, the reaction can be driven electrochemically. The electrochemical process can use a similar aqueous LiOH solution as the electrolyte used to perform the chemical lithiation reaction. In the case of using a carbon or metal anode where the counter electrode reaction is the evolution of oxygen, a voltage or current must be applied to the electrochemical vessel to drive the reaction. For example, the electrochemical vessel containing a slurry of recovered Li₁₋ₓCoO₂ cathode material and a carbon anode in aqueous LiOH, may be polarized to a voltage of −0.5V to achieve full lithiation of the LiCoO₂ material. If a lithium metal electrode is used as the anode in the electrochemical vessel of this invention, as in Example 1 below, the lithiation reaction can occur spontaneously when the cell is shorted through a resistor until the voltage reaches the desired level (ex. 2.8 V vs. lithium).

In another aspect of this invention, the slurry method of re-lithiating the cathode materials from the waste stream is done as a continuous process. In one aspect of the method the chemical and electrochemical processes are completed as separate processes to permit conditions to be optimized for each type of process. For example, the recovered cathode material may be mixed into a vessel containing an aqueous LiOH solution. The LiOH solution may have been generated in part from washing the anode material with water under an inert atmosphere (ex. Ar) to remove lithium from the graphite or other anode material, yielding a LiOH-containing water solution and de-lithiated graphite. The waste LiOH-containing solution can be separated from the graphite material and used to re-lithiate the cathode material in a separate process. In another aspect of this invention the graphite and the cathode materials are mixed simultaneously in an aqueous bath under an inert atmosphere such that excess lithium from the graphite can be transferred in part to the cathode material.

As part of the continuous process, once the chemical lithiation is complete then the solution and material or slurry is transferred by pumping to a second electrochemical vessel in which the electrochemical lithiation of the cathode slurry is completed. If necessary the pH and the LiOH or salt content of the transferred slurry can be adjusted to optimize the electrochemical reaction process.

For the electrochemical process, the mixing speed of the blade, the solution viscosity and the internal design of the vessel and working electrode surface, among other things, are preferably optimized to maximize the number of contact events and the length of contact time of the slurry active material particles with the working electrode surface of the vessel as the slurry is continuously mixed. The more contact events with the working electrode, the faster the state of charge of the cathode active material will be changed.

### EXAMPLES

### Example 1

In this example the cathode laminate from spent lithium-ion cells is processed to produce a powder containing 90% by weight of mixed oxide cathode materials Li₁₋ₓNiCoMnO₂ and Li_{1-y}Mn₂O₄(where x=0.1 and y=0.08, and x and y correspond to the average state of charge, or amount of lithium lost from the original oxide materials during use of the cell), and 10% by weight of carbon conductive additive and PVDF binder. The powder composition is mixed into an aqueous solution of 1M LiOH in an electrochemical vessel illustrated in FIG. 1. Most of the vessel surface acts as a working electrode, including the blade used to continuously mix the slurry. One or more counter electrodes are placed within the vessel walls. In one aspect of the invention the counter electrodes are lithium metal separated from the aqueous solution by a water-stable, lithium-ion conducting ceramic material such as LISICON (FIG. 2). The counter electrode or electrodes are electrically isolated from the working electrode portion of the vessel.

The mixing blade runs continuously and a voltage is established between the working and counter electrodes based on the average state of charge of the slurry components vs. the lithium metal electrode. The voltage established for the electrochemical vessel is ˜3.6V at equilibrium. The working and counter electrodes are then allowed to discharge through an external circuit, which includes a galvanostat or potentiostat or simple set of resistors to control the current passed. The vessel is allowed to discharge until the voltage is ˜2.8V, corresponding to full lithiation of the cathode materials to make LiNiCoMnO₂ and LiMn₂O₄. The slurry is then removed from the vessel and the solids are separated from the solution by filtration, followed by rinsing and drying.

What is claimed is:

1. A process for preparing a cathode active material for lithium-ion batteries, comprising preparing a slurry by mixing a lithium-deficient cathode active material for lithium-ion batteries with a solution containing lithium-ions; and
applying a direct current in the slurry using a working electrode and a counter electrode.

2. The process of claim 1, wherein the direct current is applied so as to establish an equilibrium voltage between the working electrode and the counter electrode corresponding to the fully lithiated state of the cathode active material.

3. The process of claim 1, wherein
the solution containing lithium-ions is an aqueous solution of LiOH, LiNO₃, Li₂SO₄, or other lithium salt; or the solution containing lithium-ions is an electrolyte solution for lithium-ion batteries;
the solution containing lithium-ions has a lithium-ion concentration of 0.1-5 mol/L.

4. The process of claim 1, wherein the slurry is placed into an electrochemical vessel, the walls of which act as the working electrode, and the counter electrode is provided penetrating through parts of the walls of the electrochemical vessel while being electrically isolated from the vessel.

5. The process of claim 4, wherein the electrochemical vessel is provided with a mixing blade to stir the slurry during the electrochemical lithiation and also act as the working electrode.

6. The process of claim 4, wherein the counter electrode comprises lithium metal, and the counter electrode is separated from the slurry by a membrane or material that is permeable to lithium ions.

7. The process of claim 4, wherein the electrochemical vessel is further provided with a conductive mesh which acts as the working electrode and through which the slurry is pumped continuously.

8. The process of claim 1, wherein the lithium-deficient cathode active material is selected from the group consisting of Li₁₋ₓCoO₂, Li₁₋ₓNiCoO₂, Li₁₋ₓNiCoMnO₂, Li₁₋ₓMn₂O_{4,}Li₁₋ₓNiCoAlO₂, Li₁₋ₓFePO₄ (where x is greater than 0 and less than 1).

9. A method for recycling a cathode active material from lithium-ion batteries, comprising
collecting a lithium-deficient cathode active material from lithium-ion batteries, and preparing a slurry by mixing the lithium-deficient cathode active material with a solution containing lithium-ions; and
applying a direct current in the slurry using a working electrode and a counter electrode.

10. The method of claim 9, further comprising collecting the cathode active material from the slurry after an equilibrium voltage corresponding to the fully lithiated state of the cathode active material is established between the working electrode and the counter electrode.

11. The method of claim 10, wherein the cathode active material is collected by filtration or evaporation.

12. The method of claim 9, wherein
the solution containing lithium-ions is an aqueous solution of LiOH, LiNO₃, Li₂SO₄, or other lithium salt; or the solution containing lithium-ions is an electrolyte solution for lithium-ion batteries;
the solution containing lithium-ions has a lithium-ion concentration of 0.1-5 mol/L.

13. The method of claim 9, wherein the slurry is placed into an electrochemical vessel, the walls of which act as the working electrode, and the counter electrode is provided penetrating through parts of the walls of the electrochemical vessel while being electrically isolated from the vessel.

14. The method of claim 13, wherein the electrochemical vessel is provided with a mixing blade to stir the slurry during the electrochemical lithiation and also act as the working electrode.

15. The method of claim 13, wherein the counter electrode comprises lithium metal, and the counter electrode is separated from the slurry by a membrane or material that is permeable to lithium ions.

16. The method of claim 13, wherein the electrochemical vessel is further provided with a conductive mesh which acts as the working electrode and through which the slurry is pumped continuously.

17. The method of claim 9, wherein the lithium-deficient cathode active material is selected from the group consisting of Li₁₋ₓCoO₂, Li₁₋ₓNiCoO₂, Li₁₋ₓNiCoMnO₂, Li₁₋ₓMn₂O₄Li₁₋ₓNiCoAlO₂, Li₁₋ₓFePO₄ (where x is greater than 0 and less than 1).
